(19) United States
(12) Patent Application Publication
(10) Pub. No.: US 2006/0250681 A1
(43) Pub. Date: Nov. 9, 2006

(54) Inter-network optical fiber sharing system

(75) Inventors: Sung-Bum Park, Suwon-si (KR); Due-Kwang Jung, Suwon-si (KR); Seong-Taek Hwang, Pyeongtack-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/407,486

(22) Filed: Apr. 20, 2006

(30) Foreign Application Priority Data
Apr. 21, 2005 (KR) 2005-33323

(51) Int. Cl. H01S 3/00

(52) U.S. Cl. 359/337.4

(57) ABSTRACT

Disclosed is an inter-network optical fiber system comprising: a first optical switching part connected to a first feeder fiber, to connect a first central office to a second feeder fiber of a second central office through a second optical switching part when no upstream optical signal having a first upstream wavelength bandwidth is received from the first feeder fiber, and the second optical switching part connected to the second feeder fiber connects the second central office to the first feeder fiber through the first optical switching part when no upstream optical signal having a second upstream wavelength bandwidth is received from the second feeder fiber.

### CLAIM OF PRIORITY

This application claims priority to an application entitled “Inter-network Optical Fiber Sharing System,” filed with the Korean Intellectual Property Office on Apr. 21, 2005 and assigned Serial No. 2005-0033323, the contents of which is incorporated herein by reference.

### BACKGROUND OF THE INVENTION

1. Field of the Invention

The present invention relates to a system for healing optical fiber failures that may occur in an optical network, and more particularly to a system for healing optical fiber failures in a passive optical network (“PON”).

2. Description of the Related Art

Wavelength Division Multiplexed Passive Optical Networks (“WDM-PONs”), which assign a different wavelength to each subscriber, can ensure communication security and easily accept expansion of communication services or communication capacity when requested by subscribers. Also, WDM PONs can easily increase the number of subscribers by adding wavelengths that will be assigned to new subscribers. WDM PONs generally employ a double star architecture that establishes a connection between a central office CO and a remote node RN (installed in an area where a plurality of subscribers are distributed within a near distance). The CO-RN connection uses a single feeder fiber and the connection between the RN and each subscriber device uses an independent distribution fiber. Multiplexed downstream optical signals are transmitted to the remote node through the feeder fiber. Demultiplexed by a wavelength division multiplexer located in the remote node. Then, they are finally sent to each subscriber through the distribution fiber. Upstream optical signals output from each subscriber device are transmitted to the remote node. The upstream signals input to the wavelength division multiplexer of the remote node are wavelength-division-multiplexed and then sent to the central office.

When an unexpected failure of the feeder fiber (fiber cut or degradation) occurs in a WDM PON with double star architecture, it causes a loss of data transmitted between the central office and each subscriber. Therefore, fiber failures should be detected and recovered from as rapidly as possible.

Self-healing techniques have been suggested as solutions for recovering from fiber failures. Conventional self-healing techniques connect the central office to the remote node using a working feeder fiber and a protection feeder fiber. Moreover, when a failure occurs in the working feeder fiber it switches the working feeder fiber to the protection feeder fiber.

However, if the working feeder fiber and the protection feeder fiber are installed too close to each other, simultaneous failures of both fibers may occur. In such events, the conventional self-healing methods are useless.

Therefore, it is a need to provide a new system for recovering failures in the feed fiber occurring in a star PON architecture.

### SUMMARY OF THE INVENTION

Accordingly, the present invention has been made to reduce or overcome the above-mentioned problems occurring in the prior art and provides additional advantages, by providing a system for recovering from failures in a feeder fiber occurring in a passive optical network (PON) with a star architecture.

In accordance with a first embodiment of the present invention, an inter-network optical fiber system is provided for recovering from a feeder fiber failure. The inter-network optical fiber system includes a first optical switching part connected to a first feeder fiber, to connect a first central office to a second feeder fiber through a second optical switching part of a second central office when no upstream optical signal having a first upstream wavelength bandwidth is received from the first feeder fiber. Further, the second optical switching part connected to the second feeder fiber connect the second central office to the first feeder fiber through the first optical switching part when no upstream optical signal having a second upstream wavelength bandwidth is received from the second feeder fiber.

In accordance with a second embodiment of the present invention, an inter-network optical fiber system is provided for recovering from a feeder fiber failure, the system comprising an optical switching part connected to the first feeder fiber, to connect a first central office to a second feeder fiber of a second central office when no upstream optical signal is received from the first feeder fiber; and an optical distribution part to connect the first feeder fiber to a first remote node connected to the first central office and allow output a downstream optical signal input from the first or second feeder fiber to the first remote node.

In accordance with a third embodiment of the present invention, an inter-network optical fiber system is provided for recovering from a feeder fiber failure, the system comprising an optical switching part connected to a first feeder fiber, to connect a first central office to a second feeder fiber of a second central office when no upstream optical signal is received from the first feeder fiber, wherein said optical switching part includes an optical switch having first to third ports, to connect the first central office connected to the first port to the first feeder fiber connected to the second port or the second feeder fiber connected to the third port; and a wavelength selective coupler to connect the third port of the optical switch to the second feeder fiber and allow output of a downstream optical signal input from the optical switch to the second feeder fiber.

### BRIEF DESCRIPTION OF THE DRAWINGS

The present invention will be more apparent from the following detailed description taken in conjunction with the accompanying drawings, in which:

FIG. 1 is a block diagram of an inter-network optical fiber sharing system according to a first embodiment of the present invention;

FIG. 2 illustrates a wavelength bandwidth used in the first and second PONs in FIG. 1;

FIG. 3 illustrates an N^{th} wavelength selective coupler of an N^{th} optical transceiver of the first CO in FIG. 1;

FIG. 4 illustrates a wavelength selective coupler of the first optical switching part in FIG. 1;

FIG. 5 is a block diagram to explain the operations of the inter-network optical fiber sharing system when a failure occurs in the first feeder fiber in FIG. 1;

FIG. 6 is a block diagram of an inter-network optical fiber sharing system according to a second embodiment of the present invention; and

FIG. 7 is a block diagram to explain the operations of the inter-network optical fiber sharing system when a failure occurs in the first feeder fiber in FIG. 6.

### DETAILED DESCRIPTION

Hereinafter, embodiments of the present invention will be described with reference to the accompanying drawings. For the purposes of clarity and simplicity, a detailed description of known functions and configurations incorporated herein will be omitted as it may make the subject matter of the present invention unclear.

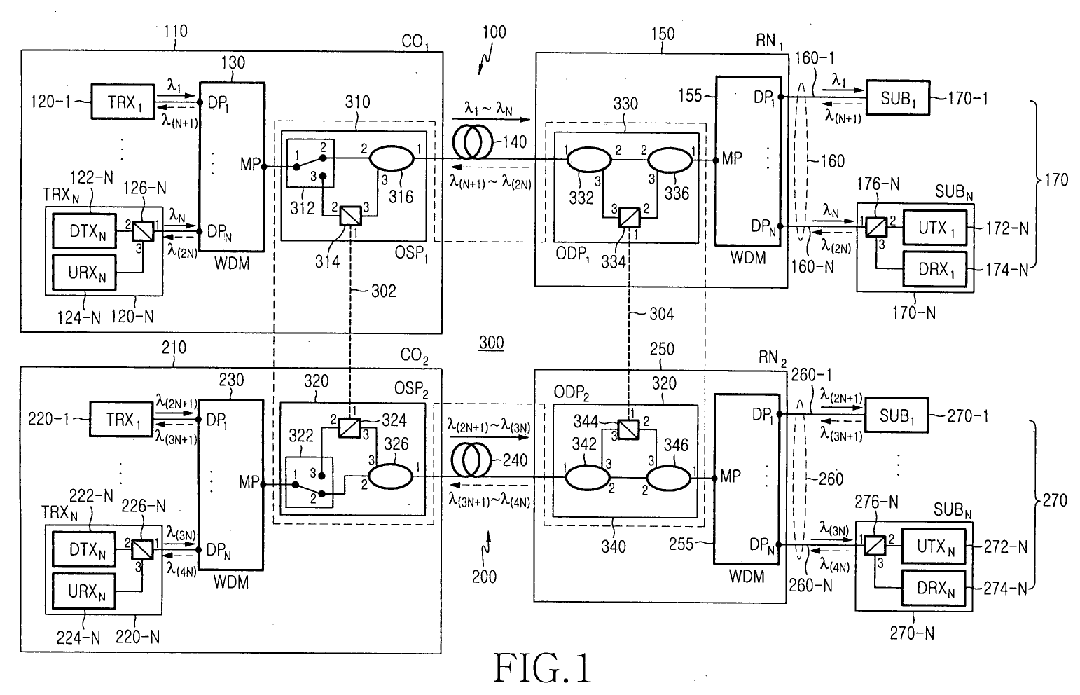

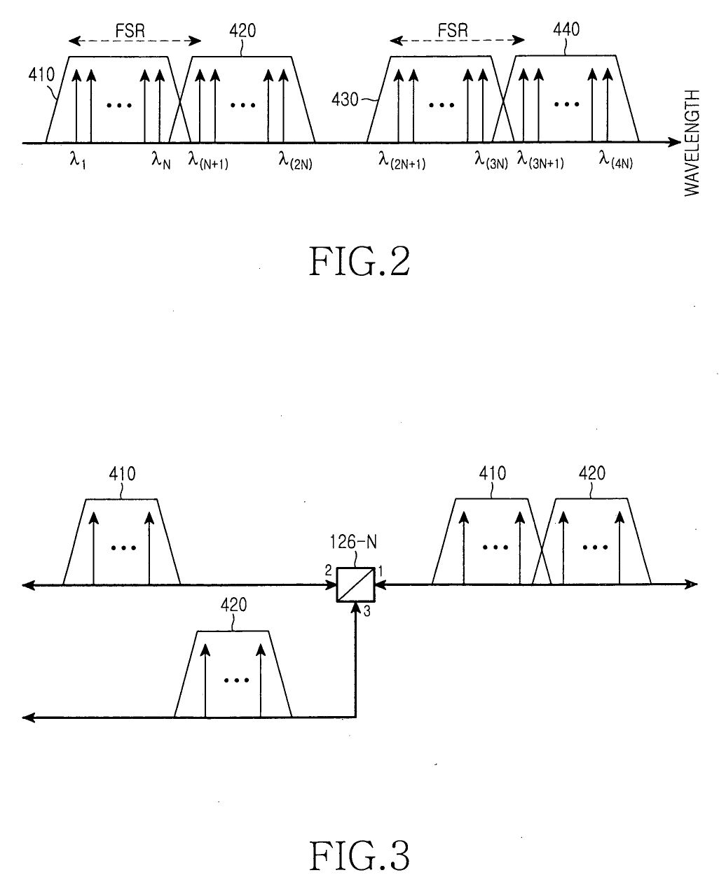

FIG. 1 is a block diagram of an inter-network optical fiber sharing system according to the first embodiment of the present invention. FIG. 2 illustrates a wavelength bandwidth used in the first and second PONs in FIG. 1. FIG. 1 illustrates a first passive optical network (PON) 100, a second passive optical network (PON) 200 and an inter-network optical fiber sharing system 300 for connecting the first and second PONs 100 and 200 to each other.

The first PON 100 includes a first central office (CO) 110, a first remote node (RN) 150 connected to the first CO 110 through a first feeder fiber 140, and first to N^{th} subscriber devices (SUB) 170-1 to 170-N of a first subscriber group 170 connected to the first RN 150 through first to N^{th} distribution fibers 160-1 to 160-N of a first distribution fiber group 160.

The second PON 200 includes a second central office (CO) 210, a second remote node (RN) 250 connected to the second CO 210 through a second feeder fiber 240, and first to N^{th} subscriber devices (SUB) 270-1 to 270-N of a second subscriber group 270 connected to the second RN 250 through first to N^{th} distribution fibers 260-1 to 260-N of a second distribution fiber group 260.

The inter-network optical fiber sharing system 300 includes a first optical switching part (OSP) 310 for connecting the first CO 110 to the first feeder fiber 140, a first optical distribution part (ODP) 330 for connecting the first feeder fiber 140 to the first RN 150, a second optical switching part (OSP) 320 for connecting the second CO 210 to the second feeder fiber 240, a second optical distribution part (ODP) 340 for connecting the second feeder fiber 240 to the second RN 250, a first protection fiber 302 for connecting the first OSP 310 to the second OSP 320, and a second protection fiber 304 for connecting the first ODP 330 to the second ODP 340.

FIG. 1 illustrates a normal state with no failure in the first and second feeder fibers 140 and 240.

The first CO 110 includes first to N^{th} optical transceivers (TRX) 120-1 to 120-N and a wavelength division multiplexer (WDM) 130.

The first to N^{th} optical transceivers 120-1 to 120-N have the same or similar configurations. The N^{th} optical transceiver 120-N includes an N^{th} downstream optical transmitter (DTX) 122-N for outputting an N^{th} downstream optical signal λ_{N} of a first downstream wavelength bandwidth 410 and an N^{th} upstream optical receiver (UTX) 124-N for receiving a 2N^{th} upstream optical signal λ_{2N} of a first upstream wavelength bandwidth 420, and an N^{th} wavelength selective coupler 126-N.

FIG. 3 illustrates the N^{th} wavelength selective coupler of the N^{th} optical transceiver of the first CO in FIG. 1. The N^{th} wavelength selective coupler 126-N has first to third ports. The first port is connected to the wavelength division multiplexer 130. The second port is connected to the N^{th} downstream optical transmitter (DTX) 122-N. The third port is connected to the N^{th} upstream optical receiver (UTX) 124-N. The N^{th} wavelength selective coupler 126-N outputs the N^{th} downstream optical signal input to the second port to the first port, while outputting the 2N^{th} upstream optical signal input to the first port to the third port.

Referring back to FIG. 1, the wavelength division multiplexer 130 has a multiplexer port and first to N^{th} demultiplexer ports. The multiplexer port is connected to the first OSP 310. The first to N^{th} demultiplexer ports are connected respectively to the first to N^{th} optical transceivers 120-1 to 120-N. The wavelength division multiplexer 130 performs wavelength-division multiplexing on the first to N^{th} downstream optical signals λ₁ to λ_{N} of the first downstream wavelength bandwidth 410, which were input to the first to N^{th} demultiplexer ports, and outputs the multiplexed downstream optical signals to the multiplexer port. Also, the wavelength division multiplexer 130 performs wavelength-division demultiplexing on the (N+1)^{th} to 2N^{th} upstream optical signals λ_{(N+1)} to λ_{(2N)} of the first upstream wavelength bandwidth 420, which were input to the multiplexer port, and sequentially outputs the demultiplexed upstream optical signals to the first to N^{th} demultiplexer ports, respectively.

The first OSP 310 includes an optical switch 312, a wavelength selective coupler 314 and an optical distributor 316.

The optical switch 312 has first to third ports. The first port is connected to the multiplexer port of the wavelength division multiplexer 130. The second port is connected to the optical distributor 316. The third port is connected to the wavelength selective coupler 314. The optical switch 312 connects the first port selectively to the second or third port. For example, in a protective condition if an upstream optical signal of the first upstream wavelength bandwidth 420 is not received from the first feeder fiber 140 (e.g., when a failure occurs in the first feeder fiber 140), the optical switch 312 connects the first port to the third port. In a normal condition, the optical switch 312 connects the first port to the second port.

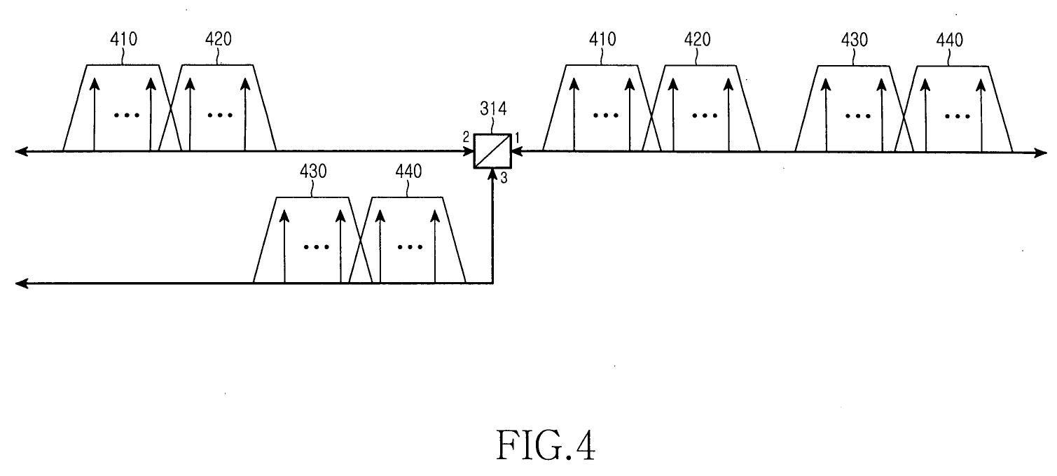

FIG. 4 illustrates the wavelength selective coupler of the first optical switching part in FIG. 1.

Referring to FIGS. 1 and 4, the wavelength selective coupler 314 has first to third ports. The first port is connected to the second OSP 320 through the first protection fiber 302. The second port is connected to the third port of the optical switch 312. The third port is connected to the optical distributor 316. The first port serves as an input/output path for the first downstream/upstream wavelength bandwidths 410 and 420 and second downstream/upstream wavelength bandwidths 430 and 440. The second port serves as an input/output path for the first downstream/upstream wavelength bandwidths 410 and 420. The third port serves as an input/output path for the second downstream/upstream wavelength bandwidths 430 and 440. The wavelength selective coupler 314 outputs an optical signal input to one of the three ports to another having the corresponding wavelength bandwidth.

The optical distributor 316 has first to third ports. The first port is connected to the first feeder fiber 140. The second port is connected to the second port of the optical switch 312. The third port is connected to the third port of the wavelength selective coupler 314. The optical distributor 316 splits an optical signal input to the first port into two parts with substantially equal intensity and outputs the two signal parts to the second and third ports. Also, the optical distributor 316 couples optical signals input to the second and third ports and outputs the coupled signals to the first port.

The first optical distribution part 330 includes first and second optical distributors 332 and 336 and a wavelength selective coupler 334.

The first optical distributor 332 has first to third ports. The first port is connected to the first feeder fiber 140. The second port is connected to the second optical distributor 336. The third port is connected to the wavelength selective coupler 334. The first optical distributor 332 splits an optical signal input to the first port into two parts with substantially equal intensity and outputs the two signal parts to the second and third ports. Also, the first optical distributor 332 couples optical signals input to the second and third ports and outputs the coupled signal to the first port.

The second optical distributor 336 has first to third ports. The first port is connected to a wavelength division multiplexer 155 of the remote node 150. The second port is connected to the second port of the first optical distributor 332. The third port is connected to the third port of the wavelength selective coupler 334. The second optical distributor 336 splits an optical signal input to the first port into two parts with substantially equal intensity and outputs the two signal parts to the second and third ports. Also, the second optical distributor 336 couples optical signals input to the second and third ports and outputs the coupled signals to the first port.

The wavelength selective coupler 334 has first to third ports. The first port is connected to the second optical distributor 340 through the second protection fiber 304. The second port is connected to the third port of the second optical distributor 336. The third port is connected to the third port of the first optical distributor 332. The first port serves as an input/output path for the first downstream/upstream wavelength bandwidths 410 and 420 and the second downstream/upstream wavelength bandwidths 430 and 440. The second port serves as an input/output path for the first downstream/upstream wavelength bandwidths 410 and 420. The third port serves as an input/output path for the second downstream/upstream wavelength bandwidths 430 and 440. The wavelength selective coupler 334 outputs an optical signal input to one of the three ports to another having the corresponding wavelength bandwidth.

The remote node 150 includes the wavelength division multiplexer 155.

The wavelength division multiplexer 155 has a multiplexer port and first to N^{th} demultiplexer ports. The multiplexer port is connected to the first port of the second optical distributor 336 of the first optical distribution part 330. The first to N^{th} demultiplexer ports are connected respectively to the distribution fibers 160-1 to 160-N of the first distribution fiber group 160. The wavelength division multiplexer 155 performs wavelength-division demultiplexing on the first to N^{th} downstream optical signals of the first downstream wavelength bandwidth 410, and sequentially outputs the demultiplexed downstream optical signals to the first to N^{th} demultiplexer ports, respectively. Also, the wavelength division multiplexer 155 performs wavelength-division multiplexing on the (N+1)^{th} to 2N^{th} upstream optical signals of the first upstream wavelength bandwidth 420, and outputs the multiplexed upstream optical signals to the multiplexer port.

The first to N^{th} subscriber devices 170-1 to 170-N of the first subscriber group 170 have the same or similar configuration. The N^{th} subscriber device 170-N includes an N^{th} upstream optical transmitter 172-N for outputting the 2N^{th} upstream optical signal of the first upstream wavelength bandwidth 420, an N^{th} downstream optical receiver 174-N for receiving the N^{th} downstream optical signal of the first downstream wavelength bandwidth 410, and an N^{th} wavelength selective coupler 176-N. The N^{th} wavelength selective coupler 176-N has first to third ports. The first port is connected to the N^{th} distribution fiber 160-N of the first distribution fiber group 160. The second port is connected to the N^{th} upstream optical transmitter 172-N. The third port is connected to the N^{th} downstream optical receiver 174-N. The N^{th} wavelength selective coupler 176-N outputs the 2N^{th} upstream optical signal input to the second port to the first port, while outputting the N^{th} downstream optical signal input to the first port to the third port.

The second CO 210 includes first to N^{th} optical transceivers 220-1 to 220-N and a wavelength division multiplexer 230.

The first to N^{th} optical transceivers 220-1 to 220-N have the same or similar configuration. The N^{th} optical transceiver 220-N includes an N^{th} downstream optical transmitter 222-N for outputting a 3N^{th} downstream optical signal λ_{(3N)} of the second downstream wavelength bandwidth 430 and an N^{th} upstream optical receiver 224-N for receiving a 4N^{th} upstream optical signal λ_{(4N)} of the second upstream wavelength bandwidth 440, and an N^{th} wavelength selective coupler 226-N. The N^{th} wavelength selective coupler 226-N has first to third ports. The first port is connected to the wavelength division multiplexer 230. The second port is connected to the N^{th} downstream optical transmitter 222-N. The third port is connected to the N^{th} upstream optical receiver 224-N. The N^{th} wavelength selective coupler 226-N outputs the 3N^{th} downstream optical signal input to the second port to the first port, while outputting the 4N^{th} upstream optical signal input to the first port to the third port.

The wavelength division multiplexer 230 has a multiplexer port and first to N^{th} demultiplexer ports. The multiplexer port is connected to the second OSP 320. The first to N^{th} demultiplexer ports are connected respectively to the first to N^{th} optical transceivers 220-1 to 220-N. The wavelength division multiplexer 230 performs wavelength-division multiplexing on (2N+1)^{th} to 3N^{th} downstream optical signals of the second downstream wavelength bandwidth 430, and outputs the multiplexed downstream optical signals to the multiplexer port. Also, the wavelength division multiplexer 230 performs wavelength-division demultiplexing on (3N+1)^{th} to 4N^{th} upstream optical signals of the second upstream wavelength bandwidth 440, and sequentially outputs the demultiplexed upstream optical signals to the first to N^{th} demultiplexer ports, respectively.

The second OSP 320 includes an optical switch 322, a wavelength selective coupler 324 and an optical distributor 326.

The optical switch 322 has first to third ports. The first port is connected to the multiplexer port of the wavelength division multiplexer 230. The second port is connected to the optical distributor 326. The third port is connected to the wavelength selective coupler 324. The optical switch 322 connects the first port selectively to the second or third port. For example, in a protective condition if an upstream optical signal of the second upstream wavelength bandwidth 440 is not received from the second feeder fiber 240 (e.g., when a failure occurs in the second feeder fiber 240), the optical switch 322 connects the first port to the third port. In a normal condition, the optical switch 322 connects the first port to the second port.

The wavelength selective coupler 324 has first to third ports. The first port is connected to the first port of the wavelength selective coupler 314 of the first OSP 310 through the first protection fiber 302. The second port is connected to the third port of the optical switch 322. The third port is connected to the optical distributor 326. The first port serves as an input/output path for the first downstream/upstream wavelength bandwidths 410 and 420 and second downstream/upstream wavelength bandwidths 430 and 440. The second port serves as an input/output path for the second downstream/upstream wavelength bandwidths 430 and 440. The third port serves as an input/output path for the first downstream/upstream wavelength bandwidths 410 and 420. The wavelength selective coupler 324 outputs an optical signal input to one of the three ports to another having the corresponding wavelength bandwidth.

The optical distributor 326 has first to third ports. The first port is connected to the second feeder fiber 240. The second port is connected to the second port of the optical switch 322. The third port is connected to the third port of the wavelength selective coupler 324. The optical distributor 326 splits an optical signal input to the first port into two parts with substantially equal intensity and outputs the two signal parts to the second and third ports. Also, the optical distributor 326 couples optical signals input to the second and third ports and outputs the coupled signals to the first port.

The second optical distribution part 340 includes first and second optical distributors 342 and 346 and a wavelength selective coupler 344.

The first optical distributor 342 has first to third ports. The first port is connected to the second feeder fiber 240. The second port is connected to the second optical distributor 346. The third port is connected to the wavelength selective coupler 344. The first optical distributor 342 splits an optical signal input to the first port into two parts with substantially equal intensity and outputs the two signal parts to the second and third ports. Also, the first optical distributor 342 couples optical signals input to the second and third ports and outputs the coupled signal to the first port.

The second optical distributor 346 has first to third ports. The first port is connected to a wavelength division multiplexer 255 of the second remote node 250. The second port is connected to the second port of the first optical distributor 342. The third port is connected to the second port of the wavelength selective coupler 344. The second optical distributor 346 splits an optical signal input to the first port into two parts with substantially equal intensity and outputs the two signal parts to the second and third ports. Also, the second optical distributor 346 couples optical signals input to the second and third ports and outputs the coupled signals to the first port.

The wavelength selective coupler 344 has first to third ports. The first port is connected to the first port of the wavelength selective coupler 334 of the first optical distributor 330 through the second protection fiber 304. The second port is connected to the third port of the second optical distributor 346. The third port is connected to the third port of the first optical distributor 342. The first port serves as an input/output path for the first downstream/upstream wavelength bandwidths 410 and 420 and the second downstream/upstream wavelength bandwidths 430 and 440. The second port serves as an input/output path for the second downstream/upstream wavelength bandwidths 430 and 440. The third port serves as an input/output path for the first downstream/upstream wavelength bandwidths 410 and 420. The wavelength selective coupler 344 outputs an optical signal input to one of the three ports to another having the corresponding wavelength bandwidth.

The second remote node 250 includes the wavelength division multiplexer 255.

The wavelength division multiplexer 255 has a multiplexer port and first to N^{th} demultiplexer ports. The multiplexer port is connected to the first port of the second optical distributor 346 of the second optical distribution part 340. The first to N^{th} demultiplexer ports are connected respectively to the distribution fibers 260-1 to 260-N of the second distribution fiber group 260. The wavelength division multiplexer 255 performs wavelength-division demultiplexing on (2N+1)^{th} to 3N^{th} downstream optical signals of the second downstream wavelength bandwidth 430, and sequentially outputs the demultiplexed downstream optical signals to the first to N^{th} demultiplexer ports, respectively. Also, the wavelength division multiplexer 255 performs wavelength-division multiplexing on the (3N+1)^{th} to 4N^{th} upstream optical signals of the second upstream wavelength bandwidth 440, and sequentially outputs the multiplexed upstream optical signals to the multiplexer port.

The first to N^{th} subscriber devices 270-1 to 270-N of the second subscriber group 270 have the same or similar configuration. The N^{th} subscriber device 270-N includes an N^{th} upstream optical transmitter 272-N for outputting the 4N^{th} upstream optical signal of the second upstream wavelength bandwidth 440, an N^{th} downstream optical receiver 274-N for receiving the 3N^{th} downstream optical signal of the second downstream wavelength bandwidth 440, and an N^{th} wavelength selective coupler 276-N. The N^{th} wavelength selective coupler 276-N has first to third ports. The first port is connected to the N^{th} distribution fiber 260-N of the second distribution fiber group 260. The second port is connected to the N^{th} upstream optical transmitter 272-N. The third port is connected to the N^{th} downstream optical receiver 274-N. The N^{th} wavelength selective coupler 276-N outputs the 4N^{th} upstream optical signal input to the second port to the first port, while outputting the 3N^{th} downstream optical signal input to the first port to the third port.

Hereinafter, downstream transmission within the inter-network optical fiber sharing system 300 in a normal condition will be explained. The optical switches 312 and 322 of the first and second OSPs 310 and 320 are connected to the first and second ports, respectively.

The first to N^{th} downstream optical signals generated from the first CO 110 are input to the wavelength division multiplexer 155 of the first RN 150, passing through the optical switch 312 and optical distributor 316 of the first OSP 310, the first feeder fiber 140, and the first and second optical distributors 332 and 336 of the first ODP 330. The (2N+1)^{th} to 3N^{th} downstream optical signals generated from the second CO 210 are input to the wavelength division multiplexer 255 of the second RN 250, passing through the optical switch 322 and optical distributor 326 of the second OSP 320, the second feeder fiber 240, and the first and second optical distributors 342 and 346 of the second ODP 340.

Upstream transmission within the inter-network optical fiber sharing system 300 in a normal condition will be explained.

The (N+1)^{th} to 2N^{th} upstream optical signals generated from the first to N^{th} subscriber devices 170-1 to 170-N of the first subscriber group 170 are multiplexed by the wavelength division multiplexer 155 of the first RN 150. Then the multiplexed upstream optical signals are input to the wavelength division multiplexer 130 of the first CO 110, passing through the second and first optical distributors 336 and 332 of the first ODP 330, the first feeder fiber 140, and the optical distributor 316 and optical switch 312 of the first OSP 310. The (3N+1)^{th} to 4N^{th} upstream optical signals generated from the first to N^{th} subscriber devices 270-1 to 270-N of the second subscriber group 270 are multiplexed by the wavelength division multiplexer 255 of the second RN 250. Then it is input to the wavelength division multiplexer 230 of the second CO 210, passing through the second and first optical distributors 346 and 342 of the second ODP 340, the second feeder fiber 240, and the optical distributor 326 and optical switch 322 of the second OSP 320.

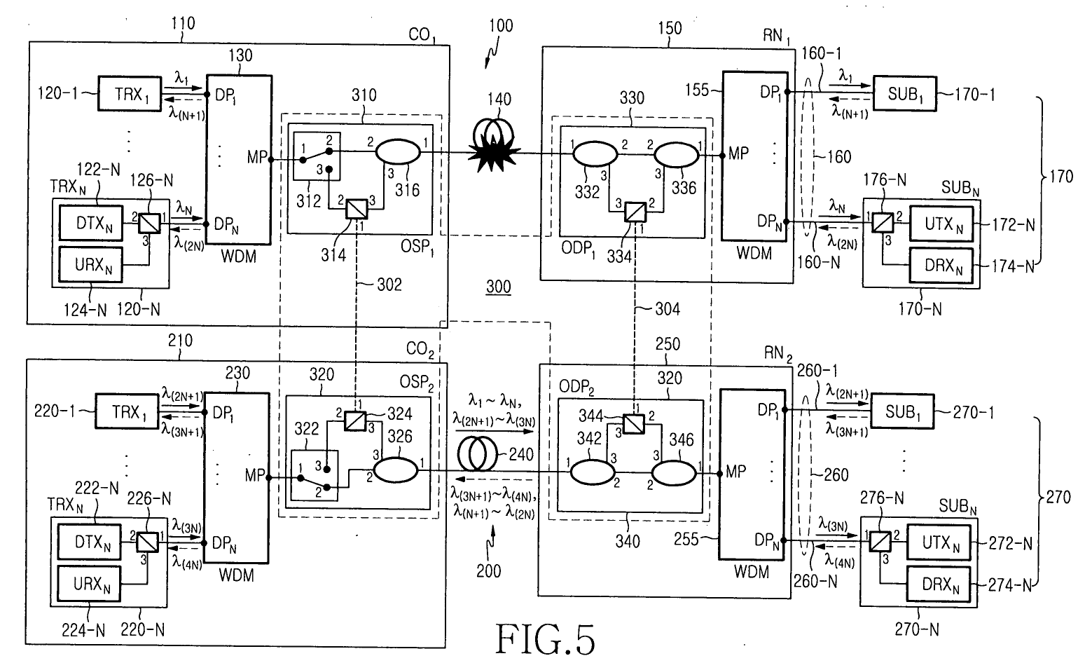

FIG. 5 is a block diagram to explain the operations of the inter-network optical fiber sharing system 300 when a failure occurs in the first feeder fiber 140 in FIG. 1.

Hereinafter, downstream transmission in the inter-network optical fiber sharing system 300 when a failure occurs in the first feeder fiber 140 will be explained. The optical switch 312 of the first OSP 310 connects the first port to the third port. The optical switch 322 of the second OSP 320 connects the first port to the second port. For example, the optical switch 312 of the first OSP 310 detects when no upstream optical signal is input from the first feeder fiber 140 and performs switching. At this time, the optical switch 322 of the second OSP 320 does not perform switching because an upstream optical signal is normally received from the second feeder fiber 240.

The first to N^{th} downstream optical signals generated from the first CO 110 are input to the wavelength division multiplexer 155 of the first RN 150, passing through the optical switch 312 and wavelength selective coupler 314 of the first OSP 310, the first protection fiber 302, the wavelength selective coupler 324 and optical distributor 326 of the second OSP 320, the second feeder fiber 240, the first optical distributor 342 and wavelength selective coupler 344 of the second ODP 340, the second protection fiber 304, and the wavelength selective coupler 334 and second optical distributor 336 of the first ODP 330. The (2N+1)^{th} to 3N^{th} downstream optical signals generated from the second CO 210 are input to the wavelength division multiplexer 255, passing through the optical switch 322 and optical distributor 326 of the second OSP 320, the second feeder fiber 240, and the first and second optical distributors 342 and 346 of the second ODP 340.

Hereinafter, upstream transmission in the inter-network optical fiber sharing system 300 when a failure occurs in the first feeder fiber 140 will be explained.

The (N+1)^{th} to 2N^{th} upstream optical signals generated from the first to N^{th} subscriber devices 170-1 to 170-N of the first subscriber group 170 are multiplexed by the wavelength division multiplexer 155 of the first RN 150. Then it is input to the wavelength division multiplexer 130 of the first CO 110, passing through the second optical distributor 336 and wavelength selective coupler 334 of the first ODP 330, the second protection fiber 304, the wavelength selective coupler 344 and first optical distributor 342 of the second ODP 340, the second feeder fiber 240, the optical distributor 326 and wavelength selective coupler 324 of the second OSP 320, the first protection fiber 302, and the wavelength selective coupler 314 and optical switch 312 of the first OSP 310. The (3N+1)^{th} to 4N^{th} upstream optical signals generated from the first to N^{th} subscriber devices 270-1 to 270-N of the second subscriber group 270 are multiplexed by the wavelength division multiplexer 255 of the second RN 250. Then it is input to the wavelength division multiplexer 230 of the second CO 210, passing sequentially through the second and first optical distributors 346 and 342 of the second ODP 340, the second feeder fiber 240, and the optical distributor 326 and optical switch 322 of the second OSP 320.

In accordance with a first embodiment of the present invention, the optical switches 312 and 322 of the first and second OSPs 310 and 320 detect an upstream optical signal output to the first port through partial splitting of the signal in order to detect any failure of the feeder fiber. To this end, each of the optical switches 312 and 322 may include an optical coupler and an optical detector. The first and second COs 110 and 210 can detect a feeder fiber failure and control switching of a corresponding optical switch by monitoring whether an upstream optical signal is received to the upstream optical receiver.

In accordance with the first embodiment of the present invention, the first OSP 310, second OSP 320, first ODP 330 and second ODP 340 are located in the first CO 110, second CO 210, first RN 150 and second RN 250, respectively. In accordance with a second embodiment of the present invention, an inter-network optical fiber sharing system is separated from the central offices and the remote nodes.

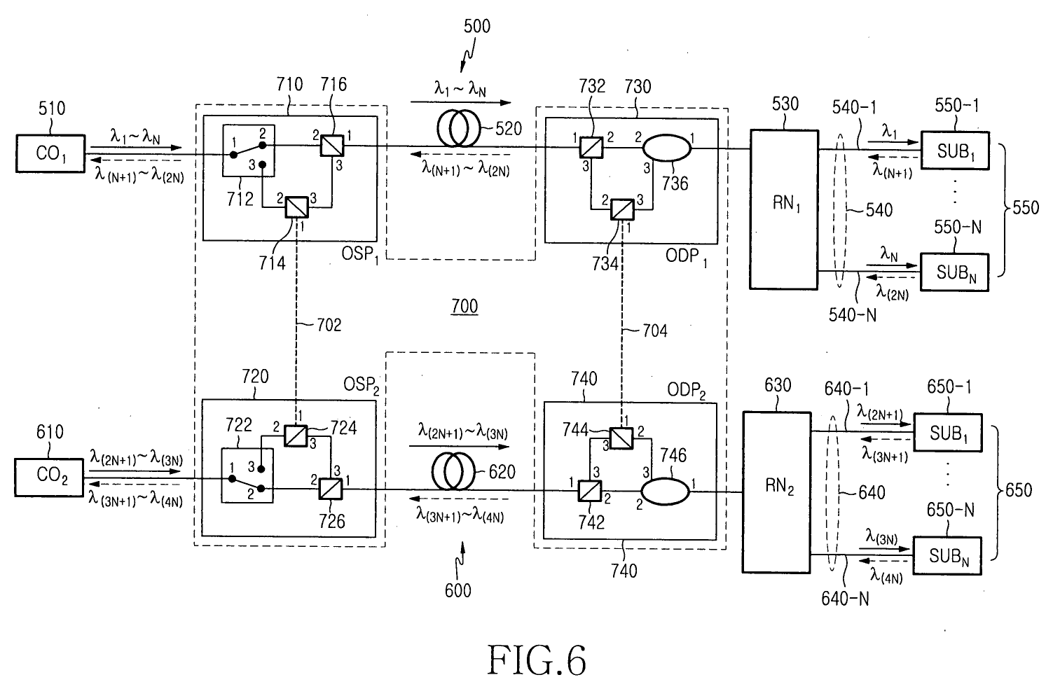

FIG. 6 is a block diagram of an inter-network optical fiber sharing system 700 according to the second embodiment of the present invention. The inter-network optical fiber sharing system 700 in FIG. 6 is similar to the system 300 in FIG. 1, with differences in that (1) wavelength selective couplers replace the optical distributors 316 and 326 of the first and second OSP 310 and 320 in the system 300, (2) wavelength selective couplers replace the first optical distributors 332 and 342 of the first and second ODP 330 and 340 in the system 300, and (3) the system 700 is separated from the COs and the RNs.

FIG. 6 illustrates a first passive optical network (PON) 500, a second passive optical network (PON) 600 and an inter-network optical fiber sharing system 700 for connecting the first and second PONs 500 and 600 to each other.

The first PON 500 includes a first central office (CO) 510, a first remote node (RN) 530 connected to the first CO 510 through a first feeder fiber 520, and first to N^{th} subscriber devices 550-1 to 550-N of a first subscriber group 550 connected to the first RN 530 through first to N^{th} distribution fibers 540-1 to 540-N of a first distribution fiber group 540.

The second PON 600 includes a second central office (CO) 610, a second remote node (RN) 630 connected to the second CO 610 through a second feeder fiber 620, and first to N^{th} subscriber devices 650-1 to 650-N of a second subscriber group 650 connected to the second RN 630 through first to N^{th} distribution fibers 640-1 to 640-N of a second distribution fiber group 640.

The inter-network optical fiber sharing system 700 includes a first optical switching part (OSP) 710 for connecting the first CO 510 to the first feeder fiber 520, a first optical distribution part (ODP) 730 for connecting the first feeder fiber 520 to the first RN 530, a second optical switching part (OSP) 720 for connecting the second CO 610 to the second feeder fiber 620, a second optical distribution part (ODP) 740 for connecting the second feeder fiber 620 to the second RN 630, a first protection fiber 702 for connecting the first OSP 710 to the second OSP 720, and a second protection fiber 704 for connecting the first ODP 730 to the second ODP 740.

The first OSP 710 includes an optical switch 712, a first wavelength selective coupler 714 and a second wavelength selective coupler 716.

The optical switch 712 has first to third ports. The first port is connected to the first CO 510. The second port is connected to the second wavelength selective coupler 716. The third port is connected to the first wavelength selective coupler 714. The optical switch 712 connects the first port selectively to the second or third port. For example, in a protective condition if an upstream optical signal of the first upstream wavelength bandwidth is not received from the first feeder fiber 520 (e.g., when a failure occurs in the first feeder fiber 520), the optical switch 712 connects the first port to the third port. In a normal condition, the optical switch 712 connects the first port to the second port.

The first wavelength selective coupler 714 has first to third ports. The first port is connected to the second OSP 720 through the first protection fiber 702. The second port is connected to the third port of the optical switch 712. The third port is connected to the second wavelength selective coupler 716. The first port serves as an input/output path for the first downstream/upstream wavelength bandwidths and the second downstream/upstream wavelength bandwidths. The second port serves as an input/output path for the first downstream/upstream wavelength bandwidths. The third port serves as an input/output path for the second downstream/upstream wavelength bandwidths. The first wavelength selective coupler 714 outputs an optical signal input to one of the three ports to another having the corresponding wavelength bandwidth.

The second wavelength selective coupler 716 has first to third ports. The first port is connected to the first feeder fiber 520. The second port is connected to the second port of the optical switch 712. The third port is connected to the third port of the first wavelength selective coupler 714. The second wavelength selective coupler 716 splits an optical signal input to the first port into two parts with substantially equal intensity and outputs the two signal parts to the second and third ports. Also, the second wavelength selective coupler 716 couples optical signals input to the second and third ports and outputs the coupled signals to the first port.

The first ODP 730 includes first and second wavelength selective couplers 732 and 734 and an optical distributors 736.

The first wavelength selective coupler 732 has first to third ports. The first port is connected to the first feeder fiber 520. The second port is connected to the optical distributor 736. The third port is connected to the second wavelength selective coupler 734. The first port serves as an input/output path for the first downstream/upstream wavelength bandwidths and the second downstream/upstream wavelength bandwidths. The second port serves as an input/output path for the first downstream/upstream wavelength bandwidths. The third port serves as an input/output path for the second downstream/upstream wavelength bandwidths. The first wavelength selective coupler 732 outputs an optical signal input to one of the three ports to another having the corresponding wavelength bandwidth.

The optical distributor 736 has first to third ports. The first port is connected to the first RN 530. The second port is connected to the second port of the first wavelength selective coupler 732. The third port is connected to the second port of the second wavelength selective coupler 734. The optical distributor 736 splits an optical signal input to the first port into two parts with substantially equal intensity and outputs the two signal parts to the second and third ports. Also, the optical distributor 736 couples optical signals input to the second and third ports and outputs the coupled signal to the first port.

The second wavelength selective coupler 734 has first to third ports. The first port is connected to the second ODP 740 through the second protection fiber 704. The second port is connected to the third port of the optical distributor 736. The third port is connected to the third port of the first wavelength selective coupler 732. The first port serves as an input/output path for the first downstream/upstream wavelength bandwidths and the second downstream/upstream wavelength bandwidths. The second port serves as an input/output path for the first downstream/upstream wavelength bandwidths. The third port serves as an input/output path for the second downstream/upstream wavelength bandwidths. The second wavelength selective coupler 734 outputs an optical signal input to one of the three ports to another having the corresponding wavelength bandwidth.

The second OSP 720 includes an optical switch 722, a first wavelength selective coupler 724 and a second wavelength selective coupler 726.

The optical switch 722 has first to third ports. The first port is connected to the second CO 610. The second port is connected to the second wavelength selective coupler 726. The third port is connected to the first wavelength selective coupler 724. The optical switch 722 connects the first port selectively to the second or third port. For example, in a protective condition if an upstream optical signal of the second upstream wavelength bandwidth is not received from the second feeder fiber 620 (e.g., when a failure occurs in the second feeder fiber 620), the optical switch 722 connects the first port to the third port. In a normal condition, the optical switch 722 connects the first port to the second port.

The first wavelength selective coupler 724 has first to third ports. The first port is connected to the first port of the first wavelength selective coupler 714 of the first OSP 710 through the first protection fiber 702. The second port is connected to the third port of the optical switch 722. The third port is connected to the second wavelength selective coupler 726. The first port serves as an input/output path for the first downstream/upstream wavelength bandwidths and second downstream/upstream wavelength bandwidths. The second port serves as an input/output path for the second downstream/upstream wavelength bandwidths. The third port serves as an input/output path for the first downstream/upstream wavelength bandwidths. The first wavelength selective coupler 724 outputs an optical signal input to one of the three ports to another having the corresponding wavelength bandwidth.

The second wavelength selective coupler 726 has first to third ports. The first port is connected to the second feeder fiber 620. The second port is connected to the second port of the optical switch 722. The third port is connected to the third port of the first wavelength selective coupler 724. The first port serves as an input/output path for the first downstream/upstream wavelength bandwidths and second downstream/upstream wavelength bandwidths. The second port serves as an input/output path for the second downstream/upstream wavelength bandwidths. The third port serves as an input/output path for the first downstream/upstream wavelength bandwidths. The second wavelength selective coupler 726 outputs an optical signal input to one of the three ports to another having the corresponding wavelength bandwidth.

The second ODP 740 includes first and second wavelength selective couplers 742 and 744 and an optical distributor 746.

The first wavelength selective coupler 742 has first to third ports. The first port is connected to the second feeder fiber 620. The second port is connected to the optical distributor 746. The third port is connected to the second wavelength selective coupler 744. The first port serves as an input/output path for the first downstream/upstream wavelength bandwidths and the second downstream/upstream wavelength bandwidths. The second port serves as an input/output path for the second downstream/upstream wavelength bandwidths. The third port serves as an input/output path for the first downstream/upstream wavelength bandwidths. The first wavelength selective coupler 742 outputs an optical signal input to one of the three ports to another having the corresponding wavelength bandwidth.

The optical distributor 746 has first to third ports. The first port is connected to the second RN 630. The second port is connected to the second port of the first wavelength selective coupler 742. The third port is connected to the second port of the second wavelength selective coupler 744. The optical distributor 746 splits an optical signal input to the first port into two parts with substantially equal intensity and outputs the two signal parts to the second and third ports. Also, the optical distributor 746 couples optical signals input to the second and third ports and outputs the coupled signal to the first port.

The second wavelength selective coupler 744 has first to third ports. The first port is connected to the first port of the second wavelength selective coupler 734 of the first ODP 730 through the second protection fiber 704. The second port is connected to the third port of the optical distributor 746. The third port is connected to the third port of the first wavelength selective coupler 742. The first port serves as an input/output path for the first downstream/upstream wavelength bandwidths and the second downstream/upstream wavelength bandwidths. The second port serves as an input/output path for the second downstream/upstream wavelength bandwidths. The third port serves as an input/output path for the first downstream/upstream wavelength bandwidths. The second wavelength selective coupler 744 outputs an optical signal input to one of the three ports to another having the corresponding wavelength bandwidth.

Hereinafter, downstream transmission within the inter-network optical fiber sharing system 700 in a normal condition will be explained. The optical switches 712 and 722 of the first and second OSPs 710 and 720 are connected to the first and second ports, respectively.

The first to N^{th} downstream optical signals λ₁ to λ_{N} of the first wavelength bandwidth, which were generated from the first CO 510, are input to the first RN 530, passing through the optical switch 712 and second wavelength selective coupler 716 of the first OSP 710, the first feeder fiber 520, and the first wavelength selective coupler 732 and optical distributor 736 of the first ODP 730. The first to N^{th} downstream optical signals are wavelength-division demultiplexed by the first RN 530 and sequentially input to the first to N^{th} subscriber devices 550-1 to 550-N, respectively, of the first subscriber group 550. The (2N+1)^{th} to 3N^{th} downstream optical signals λ_{(2N+1)} to λ_{(3N)} generated from the second CO 610 are input to the second RN 630, passing through the optical switch 722 and second wavelength selective coupler 726 of the second OSP 720, the second feeder fiber 620, and the first wavelength selective coupler 742 and optical distributor 746 of the second ODP 740. The (2N+1)^{th} to 3N^{th} downstream optical signals are wavelength-division demultiplexed by the second RN 610 and sequentially input to the first to N^{th} subscriber devices 650-1 to 650-N, respectively of the second subscriber group 650.

Upstream transmission within the inter-network optical fiber sharing system 700 in a normal condition will be explained.

The (N+₁)^{th} to 2N^{th} upstream optical signals λ_{(N+1)} to λ_{(2N)} of the first upstream wavelength bandwidth, which were generated from the first to N^{th} subscriber devices 550-1 to 550-N of the first subscriber group 550, are multiplexed by the first RN 530. Then the multiplexed upstream optical signals are input to the first CO 510, passing through the optical distributor 736 and first wavelength selective coupler 732 of the first ODP 730, the first feeder fiber 520, and the second wavelength selective coupler 716 and optical switch 712 of the first OSP 710. The (3N+1)^{th} to 4N^{th} upstream optical signals λ_{(3N+1)} to λ_{(4N)} generated from the first to N^{th} subscriber devices 650- TO 650-N of the second subscriber group 650 are multiplexed by the second RN 630, and then input to the second CO 610, passing through the optical distributor 746 and first wavelength selective coupler 742 of the second ODP 740, the second feeder fiber 620, and the second wavelength selective coupler 726 and optical switch 722 of the second OSP 720.

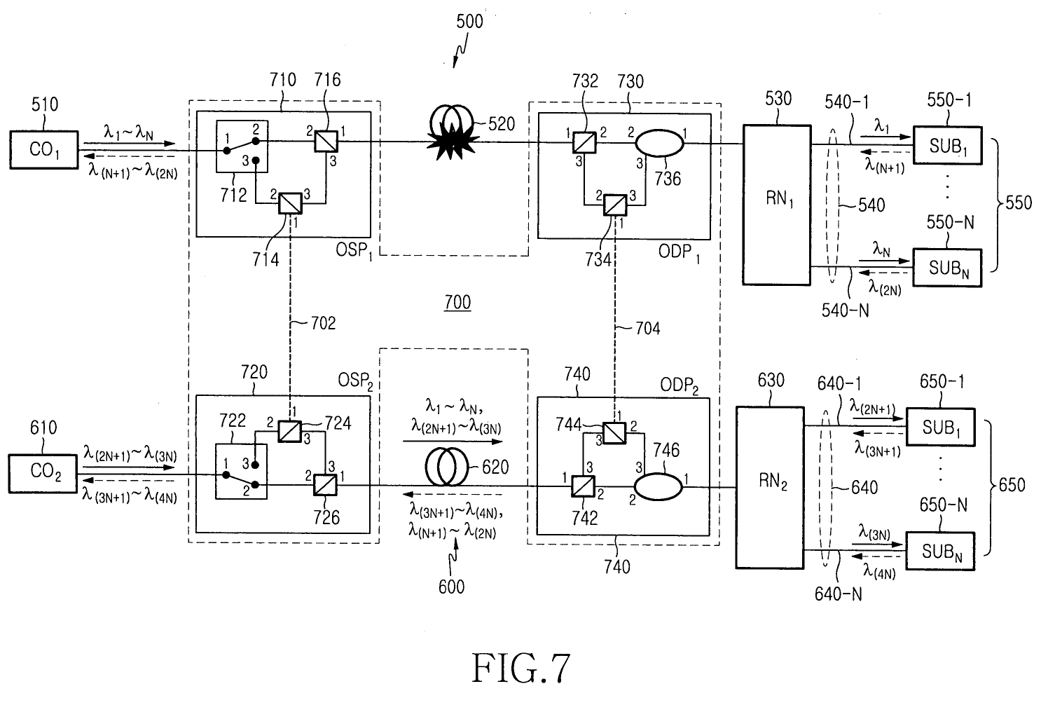

FIG. 7 is a block diagram to explain the operation of the inter-network optical fiber sharing system 700 when a failure occurs in the first feeder fiber 520 in FIG. 6.

Hereinafter, downstream transmission in the inter-network optical fiber sharing system 700 when a failure occurs in the first feeder fiber 520 will be explained. The optical switch 712 of the first OSP 710 connects the first port to the third port. The optical switch 722 of the second OSP 720 connects the first port to the second port. For example, the optical switch 712 of the first OSP 710 detects when no upstream optical signal is input from the first feeder fiber 520 and performs switching. At this time, the optical switch 722 of the second OSP 720 does not perform switching because an upstream optical signal is normally received from the second feeder fiber 620.

The first to N^{th} downstream optical signals generated from the first CO 510 are input to the first RN 530, passing through the optical switch 712 and first wavelength selective coupler 714 of the first OSP 710, the first protection fiber 702, the first and second wavelength selective couplers 724 and 726 of the second OSP 720, the second feeder fiber 620, the first and second wavelength selective couplers 742 and 744 of the second ODP 740, the second protection fiber 704, and the second wavelength selective coupler 734 and optical distributor 736 of the first ODP 730. The (2N+1)^{th} to 3N^{th} downstream optical signals generated from the second CO 610 are input to the second RN 630, passing through the optical switch 722 and second wavelength selective coupler 726 of the second OSP 720, the second feeder fiber 620, and the first wavelength selective coupler 742 and optical distributor 746 of the second ODP 740.

Hereinafter, upstream transmission in the inter-network optical fiber sharing system 700 when a failure occurs in the first feeder fiber 520 will be explained.

The (N+1)^{th} to 2N^{th} upstream optical signals generated from the first to N^{th} subscriber devices 550-1 to 550-N of the first subscriber group 550 are multiplexed by the first RN 530. Then it is input to the first CO 510, passing through the optical distributor 736 and second wavelength selective coupler 734 of the first ODP 730, the second protection fiber 704, the second wavelength selective coupler 744 and first optical distributor 742 of the second ODP 740, the second feeder fiber 620, the second wavelength selective coupler 726 and first wavelength selective coupler 724 of the second OSP 720, the first protection fiber 702, and the first wavelength selective coupler 714 and optical switch 712 of the first OSP 710. The (3N+1)^{th} to 4N^{th} upstream optical signals generated from the first to N^{th} subscriber devices 650-1 to 650-N of the second subscriber group 650 are multiplexed by the second RN 630. Then it is input to the second CO 610, passing through the optical distributor 746 and first wavelength selective coupler 742 of the second ODP 740, the second feeder fiber 620, and the second wavelength selective coupler 726 and optical switch 722 of the second OSP 720.

As explained above, when a failure occurs in a feeder fiber of one passive optical network, the inter-network optical fiber sharing system according to the present invention enables the passive optical network to share a feeder fiber of the other passive optical network, thereby recovering from the failure.

Although preferred embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. An inter-network optical fiber system comprising: a first optical switching part connected to a first feeder fiber to connect a first central office to a second feeder fiber through a second optical switching part of a second central office when no upstream optical signal having a first upstream wavelength bandwidth is received from the first feeder fiber.

2. The inter-network optical fiber system according to claim 1, further comprising: wherein the second optical switching part connected to the second feeder fiber connects the second central office to the first feeder fiber through the first optical switching part when no upstream optical signal having a second upstream wavelength bandwidth is received from the second feeder fiber.

3. The inter-network optical fiber system according to claim 2, further comprising:
a first optical distribution part to connect the first feeder fiber to the first remote node, output a downstream optical signal of a first downstream wavelength bandwidth, which was input from the first feeder fiber or a second optical distribution part, to the first remote node, and output a downstream optical signal of a second downstream wavelength bandwidth, which was input from the first feeder fiber, to the second optical distribution part; and
the second distribution part to connect the second feeder fiber to the second remote node, output a downstream optical signal of the second downstream wavelength bandwidth, which was input from the second feeder fiber or the first optical distribution part, to the second remote node, and outputting a downstream optical signal of the first downstream wavelength bandwidth, which was input from the second feeder fiber, to the first optical distribution part.

4. The inter-network optical fiber system according to claim 2, wherein said first optical switching part includes:
an optical switch to connect the first central office to the first feeder fiber or a wavelength selective coupler; and
the wavelength selective coupler to output a downstream optical signal of the first downstream wavelength bandwidth, which was input from the optical switch, to the second optical switching part.

5. The inter-network optical fiber system according to claim 4, wherein said second optical switching part includes:
an optical switch for connecting the second central office selectively to the second feeder fiber or a wavelength selective coupler; and
the wavelength selective coupler for outputting a downstream optical signal of the second downstream wavelength bandwidth, which was input from the optical switch, to the first optical switching part.

6. The inter-network optical fiber system according to claim 3, wherein said first optical distribution part includes:
an optical distributor to split a downstream optical signal input from the first feeder fiber into two parts and output the two signal parts to the first remote node and a wavelength selective coupler; and
the wavelength selective coupler to output a downstream optical signal of the second downstream wavelength bandwidth, which was input from the optical distributor, to the second optical distribution part, and a downstream optical signal of the first downstream wavelength bandwidth, which was input from the second optical distribution part, to the first remote node.

7. The inter-network optical fiber system according to claim 3, wherein said first optical distribution part includes:
a first wavelength selective coupler to output a downstream optical signal of the first downstream wavelength bandwidth, which was input from the first feeder fiber, to the first remote note, and a downstream optical signal of the second downstream wavelength bandwidth, which was input from the first feeder fiber, to a second wavelength selective coupler; and
the second wavelength selective coupler to output a downstream optical signal of the second downstream wavelength bandwidth, which was input from the first wavelength selective coupler, to the second optical distribution part, and a downstream optical signal of the first downstream wavelength bandwidth, which was input from the second optical distribution part, to the first remote node.

8. The inter-network optical fiber system according to claim 6, wherein said second optical distribution part includes:
an optical distributor to split a downstream optical signal input from the second feeder fiber into two parts and output the two signal parts to the second remote node and a wavelength selective coupler; and
the wavelength selective coupler to output a downstream optical signal of the first downstream wavelength bandwidth, which was input from the optical distributor, to the first optical distribution part, and a downstream optical signal of the second downstream wavelength bandwidth, which was input from the first optical distribution part, to the second remote node.

9. The inter-network optical fiber system according to claim 6, wherein said second optical distribution part includes:
a first wavelength selective coupler to output a downstream optical signal of the second downstream wavelength bandwidth, which was input from the second feeder fiber, to the second remote note, and a downstream optical signal of the first downstream wavelength bandwidth, which was input from the second feeder fiber, to a second wavelength selective coupler; and
the second wavelength selective coupler to output a downstream optical signal of the first downstream wavelength bandwidth, which was input from the first wavelength selective coupler, to the first optical distribution part, and a downstream optical signal of the second downstream wavelength bandwidth, which was input from the first optical distribution part, to the second remote node.

10. The inter-network optical fiber system according to claim 3, further comprising:
a first protection fiber to connect the first optical switching part to the second optical switching part; and
a second protection fiber to connect the first optical distribution part to the second optical distribution part.

11. An inter-network optical fiber system comprising:
an optical switching part connected to a first feeder fiber to connect a first central office to a second feeder fiber of a second central office when no upstream optical signal is received from the first feeder fiber; and
an optical distribution part to connect the first feeder fiber to a first remote node connected to the first central office and allow output of a downstream optical signal input from the first or second feeder fiber to the first remote node.

12. The inter-network optical fiber system according to claim 11, wherein said optical switching part includes:
an optical switch having first to third ports, to connect the first central office connected to the first port to the first feeder fiber connected to the second port or the second feeder fiber connected to the third port; and
a wavelength selective coupler to connect the third port of the optical switch to the second feeder fiber and allow output of a downstream optical signal input from the optical switch to the second feeder fiber.

13. The inter-network optical fiber system according to claim 11, further comprising:
a first protection fiber to connect the optical switching part to the second feeder fiber; and
a second protection fiber to connect the optical distribution part to the second feeder fiber.

14. An inter-network optical fiber system comprising:
an optical switching part connected to a first feeder fiber, to connect a first central office to a second feeder fiber of a second central office when no upstream optical signal is received from the first feeder fiber, wherein said optical switching part includes,
an optical switch having first to third ports, to connect the first central office connected to the first port to the first feeder fiber connected to the second port or the second feeder fiber connected to the third port; and
a wavelength selective coupler to connect the third port of the optical switch to the second feeder fiber and allow output of a downstream optical signal input from the optical switch to the second feeder fiber.

15. The inter-network optical fiber system according to claim 14, further comprising a protection fiber to connect the wavelength selective coupler to the second feeder fiber.
